(19) United States
(12) Patent Application Publication
(10) Pub. No.: US 2011/0140510 A1
(43) Pub. Date: Jun. 16, 2011

(54) CRAWLER TRACK HAVING REPLACEABLE CAULKS

(75) Inventors: Roger O'Quinn, Blacksburg, VA (US); John Dye, Washington, PA (US); Estel Owens, Claysville, PA (US)

(73) Assignee: Bucyrus America Inc.

(21) Appl. No.: 13/058,819

(22) PCT Filed: Aug. 11, 2009
(86) PCT No.: PCT/US09/53414

§ 371 Date: Feb. 11, 2011

Related U.S. Application Data
(60) Provisional application No. 61/088,664, filed on Aug. 13, 2008.

(51) Int. Cl. B62D 55/28; B62D 55/24

(52) U.S. Cl. 305/161

(57) ABSTRACT

A crawler track device includes a plurality of crawler track pads, each coupled to form a continuous crawler track, wherein each of the plurality of crawler track pads includes at least one mounting hole configured to removably receive at least one of a plurality of caulk devices that each protrude from an upper surface of the crawler track pad.

### CROSS-REFERENCE TO RELATED APPLICATIONS

This application claims priority to provisional U.S. Patent Application No. 61/088,664, filed on Aug. 13, 2008, which is hereby incorporated by reference in its entirety.

### BACKGROUND OF THE INVENTION

The present application relates to crawler tracks operable for use with heavy machinery, and in particular to crawler tracks including crawler tracks, crawler pads, and track caulks.

### RELATED ART

Heavy machinery, such as continuous miners, longwall shearers, and excavators, may be equipped with continuous crawler tracks having individual crawler pads. Traction properties of the crawler track and the crawler pads may each depend upon properties of the materials being mined. For example, traction may be reduced when the material being mined is soft, such as salt, potash, and phosphate. In addition, traction may be reduced when the material being mined is very hard or alluvial, such as granite and gravel. As a result, productivity is reduced and production costs increase.

Commonly, crawler tracks have traction improving devices, such as studs, cleats, and caulks, that are rigidly welded to outer contact surfaces of the crawler pads. However, these welded traction improving devices usually have very short useable life spans, and require frequent replacement and/or repair. As a result, these rigidly welded traction improving devices reduce productivity and increase costs. Accordingly, a system is needed that can provide improved traction for the crawler tracks, increase productivity, and reduce costs.

### BRIEF SUMMARY OF THE INVENTION

A crawler track having replaceable caulks is disclosed herein.

In one aspect, a crawler track device includes a plurality of crawler track pads, each coupled to form a continuous periodic crawler track, wherein each of the plurality of crawler track pads includes at least one mounting hole configured to removably receive at least one of a plurality of caulk devices that each protrude from an upper surface of the crawler track pad.

In another aspect, a crawler track pad includes a generally rectangular shaped pad body having a pair of through-holes disposed at opposing ends for receiving teeth of a drive sprocket and idler sprockets from a bottom surface to a top surface of the pad body, a pair of alignment members disposed on the bottom surface of the pad body and spaced apart by a first distance, a plurality of alternating finger portions and recess portions, the finger portions on a first side of the pad body oppose the recess portions on a second side of the pad body, at least one substantially circular mounting hole provided at a central location of the pad body and configured to removable receive one of a plurality of caulk devices, and a continuous recess in the top surface of the pad body having lateral portions at both sides of the at least one mounting hole, wherein the pad body includes at least one of a single one of the at least one mounting hole substantially located within the central portion of the pad body, and one of the caulk devices disposed within the single mounting hole, and a pair of the at least one mounting hole substantially located within the central portion of the pad body and spaced apart by one of the first distance and a second distance that is greater than the first distance, and one of the caulk devices disposed within each of the pair of mounting holes.

These and other features, aspects, and embodiments of the invention are described below in the section entitled “Detailed Description.”

### BRIEF DESCRIPTION OF THE DRAWINGS

Features, aspects, and embodiments of the inventions are described in conjunction with the attached drawings, in which:

FIGS. 1A and 2B are top and side views of an exemplary crawler track having replaceable caulks according to one embodiment;

FIG. 2 is a perspective view of the exemplary crawler track of FIG. 1 according to one embodiment;

FIG. 3 is a cross-sectional view along I-I of FIG. 1 according to one embodiment;

FIGS. 4A-4E are various views of an exemplary caulk device according to one embodiment;

FIGS. 5A and 5B are top and side views of an exemplary caulk retaining ring according to one embodiment;

FIGS. 6A-6D are various views of an exemplary crawler track pad according to one embodiment;

FIGS. 7A-7D are various views of another exemplary crawler track pad according to one embodiment;

FIGS. 8A-8D are various views of another exemplary crawler track pad according to one embodiment;

FIGS. 9A and 9B are top and cross-sectional views of the exemplary crawler track pad of FIGS. 6A-6D incorporating the exemplary caulk device of FIGS. 4A-4E according to one embodiment;

FIGS. 10A and 10B are top and cross-sectional views of the exemplary crawler track pad of FIGS. 7A-7D incorporating the exemplary caulk device of FIGS. 4A-4E according to one embodiment; and

FIGS. 11A and 11B are top and cross-sectional views of the exemplary crawler track pad of FIGS. 7A-7D incorporating the exemplary caulk device of FIGS. 4A-4E according to one embodiment.

### DETAILED DESCRIPTION

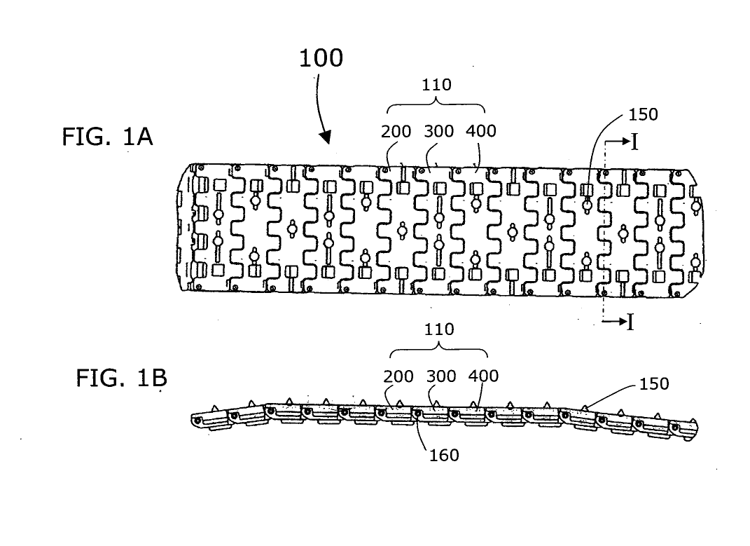

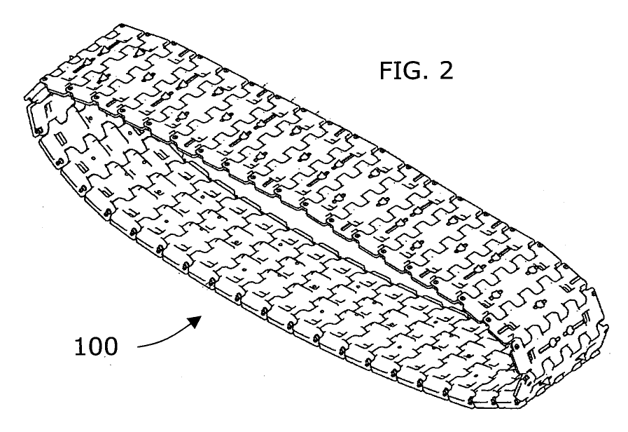

FIGS. 1A and 2B are top and side views of an exemplary crawler track having replaceable caulks according to one embodiment. In FIG. 1A, a crawler track 100 may include a periodic arrangement 110 of crawler track pads 200, 300, and 400. In addition, each of the crawler track pads 200, 300, and 400 may each include at least one caulk device 150. Here, the periodic arrangement 110 is shown to include the track sequence of crawler track pads 200-300-400. However, other sequences of the crawler track pads 200, 300, and 400 may be provided. In addition, the sequence of the crawler track pads 200, 300, and 400 may be varied according to the desired configuration of the crawler track 100. In any configuration, at least one of the caulk devices 150 are provided with each of the crawler track pads 200, 300, and 400.

In FIG. 1B, the crawler track pads 200, 300, and 400 are coupled together using a connecting shaft 160 inserted along a widthwise direction of the crawler track 100. Accordingly, each of the crawler track pads 200, 300, and 400 may pivot around each of the connecting shafts 160.

FIG. 2 is a perspective view of the exemplary crawler track of FIG. 1 according to one embodiment. In FIG. 2, the crawler track 100 may be a single continuous track operable in one of two different rotation directions. Preferably, the rotational direction includes a periodic contacting sequence with the ground of the crawler track pads 400-300-200-400-300-200- . . . etc. However, based upon various possible configurations, as described above, the periodic contacting sequence may vary based upon the configuration of the crawler track pads 200, 300, and 400. For the sake of brevity, all possible configurations are not explicitly described, but may be developed using more or less than the exemplary 3-track pad configuration described herein.

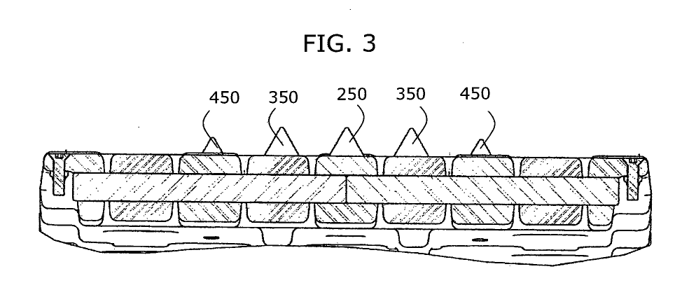

FIG. 3 is a cross-sectional view along I-I of FIG. 1 according to one embodiment. In FIG. 3, caulk devices 250, 350, and 450 are associated with the crawler track pads 200, 300, and 400, respectively. As seen, the caulk devices 350 and 450 are symmetrically provided about the caulk device 250 of the crawler track pad 200. Accordingly, as the crawler track 100 rotates about drive and follower sprockets (not shown), the caulk devices 450 of the crawler track pad 400 contacts the supporting surface first, then the caulk devices 450 of the crawler track pad 400 contacts the supporting surface second, and the caulk device 250 of the crawler track pad 200 contacts the supporting surface last. As a result, the caulk devices 250, 350, and 450, as well as the rotational direction of the crawler track 100, form a virtual “V”-shaped tread contacting the supporting surface. Here, for example, if the crawler track 100 is used in a mining operation, the supporting surface may include the material(s) which are being mined. Alternatively, for example, if the crawler track 100 is used in an earth moving operation, the supporting surface may include loose earth or aggregated material(s). In either operation, the caulk devices 250, 350, and 450 are pressed into the supporting material to improve traction of the crawler track 100.

In FIG. 3, although it appears that the caulk devices 450 are shorter than either of the caulk devices 350 and/or 250, the caulk devices 450 may be provided having substantially the same height and/or configuration as the caulk devices 250 and/or 350. Accordingly, by using substantially the same caulk devices 250, 350, and 450 for each of the crawler track pads 200, 300, and 400, each of the caulk devices 250, 350, and 450 may be mutually interchangeable.

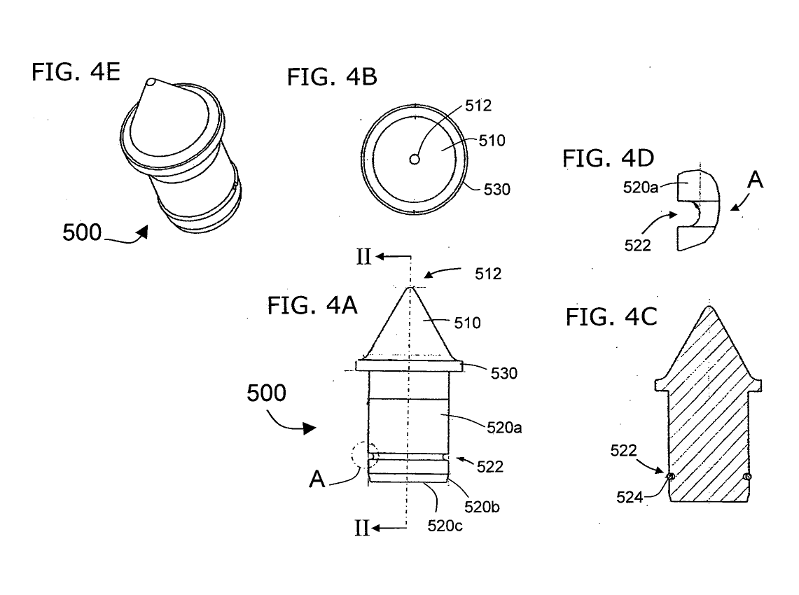

FIGS. 4A-4E are various views of an exemplary caulk device according to one embodiment. In FIG. 4A, a caulk device 500 may be formed as a unitary body having a substantially conical portion 510 and a generally cylindrical portion 520a. In addition, a flange portion 530 may be provided between the conical portion 510 and the cylindrical portion 520a. Here, the flange portion 530 may extend past an outer circumference of the cylindrical portion 520a. The conical portion 510 may include a flattened upper portion 512 and a chamfered bottom portion 520b.

In FIG. 4A, the conical portion 510 relatively smoothly transitions from an inclined plane to an upper surface of the flange portion 530. As a result, the conical portion 510 and the flange portion 530 may be more rigidly and mechanically interconnected, thereby reducing the possibility of the conical portion 510 from being sheared away from the cylindrical portion 520a. As shown in FIG. 4B, the caulk device 500 is substantially symmetrical along a lengthwise direction of the cylindrical portion 520a.

In FIGS. 4A, 4C, and 4D, a groove 522 is disposed along an exterior surface of the cylindrical portion 520a. Accordingly, a retaining ring 524 may be provided in the groove 522 for insertion of the caulk device 500 into one of the crawler track pads 200, 300, and 400 (in FIGS. 1A and 1B). Here, the retaining ring 524 is provided to extend outwardly from the groove 522.

In FIG. 4C, the caulk device 500 is shown to be formed of a single material. However, the caulk device 500 may be formed of different materials based upon the desired application of the crawler track 100 (in FIGS. 1A and 1B). For example, the conical and flange portions 510 and 530 may be formed of first-type material(s), and the cylindrical portion 520a may be formed of second-type material(s). In addition, the cylindrical portion 520a may be formed of individual parts having different mechanical and/or chemical properties.

In FIG. 4E, the caulk device 500 is shown having a generally cylindrical configuration with the conical and flange portions 510 an 530. Alternatively, the conical portion 510 may be formed having a pyramidal geometry and the flange portion 530 may be formed having a polygonal geometry. However, in preferred geometries, both the conical and flange portions 510 and 530 are symmetrical. More generally, the conical portion 510 may include different geometries such that an outer circumference increases from the upper portion 512 to the flange portion 530. Alternatively, the conical portion 510 may include different geometries such that contact with the supporting material(s) upon which the crawler track 100 (in FIGS. 1A and 1B) travels increases. For example, the conical portion 510 of the caulk device 500 may be substituted with or include polygonal shapes. Here, the conical portion 510 of the caulk device 500 may be replaced by or include a rectangular portion either at the upper portion 512 or at the flange portion 530, or somewhere in-between.

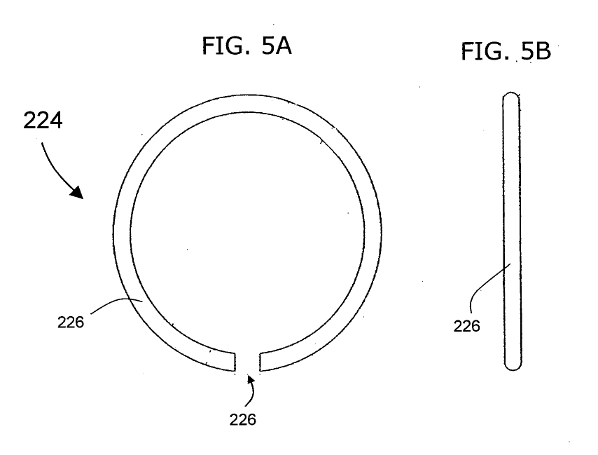

FIGS. 5A and 5B are top and side views of an exemplary caulk retaining ring according to one embodiment. In FIG. 5A, a caulk retaining ring 524 is formed of a substantially circular body 526 having a gap 528. Here, the gap 528 allows for the retaining ring 524 to be compressed, as detailed below. Accordingly, the caulk retaining ring 524 may be formed of high-tensile materials, such as steels and/or steel-alloys, for example.

As shown in FIGS. 4C and 4E, the retaining ring 524 resides within the groove 522 and protrudes from the outer surface of the cylindrical portion 520a of the caulk device 500. In addition, the retaining ring 524 may freely move into and out of the groove upon compression and expansion of the circular body 526, wherein the gap 528 correspondingly decreases and increases.

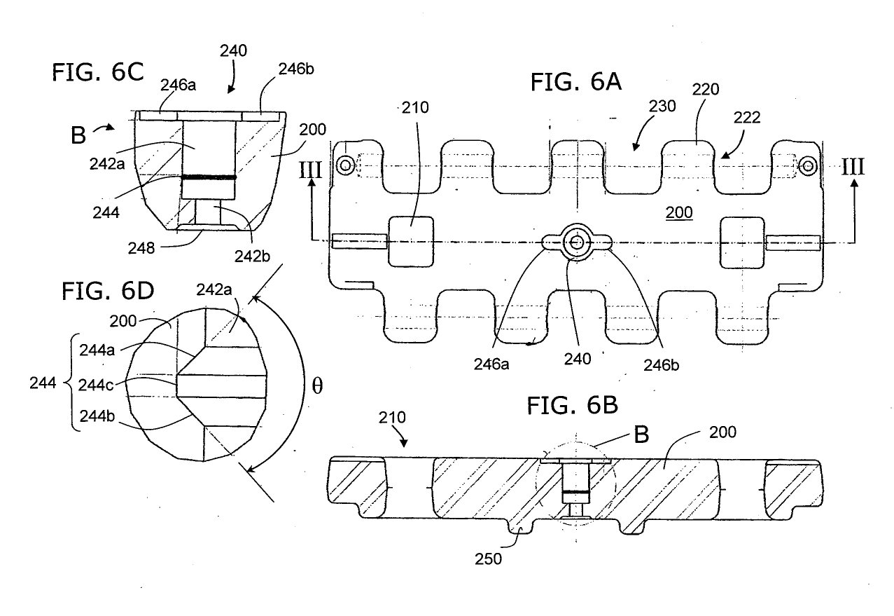

FIGS. 6A-6D are various views of an exemplary crawler track pad according to one embodiment. In FIG. 6A, a crawler track pad 200 may include a generally rectangular shaped body having a pair of through-holes 210 disposed at opposing ends. Here, for example, the through-holes 210 are generally rectangular and receive teeth of a drive sprocket and idler sprockets. In addition, the crawler track pad 200 includes a plurality of alternating finger portions 220 and recess portions 230, wherein through-holes 222 are provided within each of the finger portions 220 to receive connecting pins (not shown) to interconnect each of the crawler track pads 200, 300, and 400 (in FIGS. 1A and 1B). As shown, the finger portions 220 on a first side of the crawler track pad 200 oppose the recess portions 230 of a second side of crawler track pad 200.

In FIGS. 6A and 6B, a substantially circular mounting hole 240 is provided substantially at a central location of the crawler track pad 200. Here, the mounting hole 240 includes a continuous recess having lateral portions 246a and 246b at a top surface of the crawler track pad 200. In addition, as shown in FIG. 6B, the mounting hole 240 is positioned substantially between alignment members 250 disposed at a bottom surface of the crawler track pad 200, as well as substantially between the through-holes 210.

In FIG. 6C, the mounting hole 240 includes an upper portion 242a and a lower portion 242b. Here, a diameter of the upper portion 242a is larger than a diameter of the lower portion 242b. In addition, a lower recess 248 is provided adjacent to the lower portion 242b at the bottom surface of the crawler track pad 200, and has a diameter larger than the diameter of the lower portion 242b.

In FIGS. 6C and 6D, the upper portion 242a includes a sidewall recess 244 that extends along an inner sidewall of the upper portion 242a. The sidewall recess 244 is positioned slightly biased towards the lower portion 242b, and includes upper and lower inclined surfaces 244a and 244b interconnected by a substantially vertical surface 244c. Here, for example, an angular separation of the upper and lower inclined surfaces 244a and 244b may be about 90°. In addition, the vertical surface 244c may be substantially parallel to the inner sidewall of the upper portion 242a.

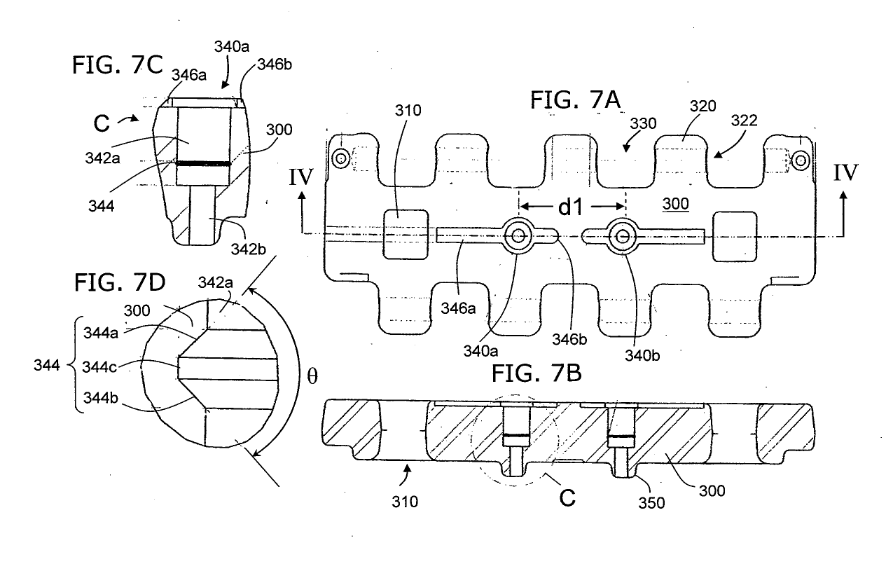

FIGS. 7A-7D are various views of another exemplary crawler track pad according to one embodiment. In FIG. 7A, a crawler track pad 300 may include a generally rectangular shape having a pair of through-holes 310 disposed at opposing ends. Here, for example, the through-holes 310 are generally rectangular and receive teeth of a drive sprocket and idler sprockets. In addition, the crawler track pad 300 includes a plurality of alternating finger portions 320 and recess portions 330, wherein through-holes 322 are provided within each of the finger portions 320 to receive connecting pins (not shown) to interconnect each of the crawler track pads 200, 300, and 400 (in FIGS. 1A and 1B). As shown, the finger portions 320 on a first side of the crawler track pad 300 oppose the recess portions 330 of a second side of crawler track pad 300.

In FIGS. 7A and 7B, a pair of substantially circular mounting holes 340a and 340b are provided substantially at a central location of the crawler track pad 300, and are separated from each other by a distance d1. Here, each of the mounting holes 340a and 340b include a continuous recess having lateral portions 346a and 346b at a top surface of the crawler track pad 300. The lateral portion 346a extends from the mounting hole 340a towards the through-hole 310 by a distance greater than the extension of the lateral portion 346b from the mounting hole 340a towards the mounting hole 340b. In addition, an end region of the lateral portion 346a is substantially flat, whereas an end region of the lateral portion 346b is rounded.

In FIG. 7B, each of the mounting holes 340a and 340b are positioned substantially within alignment members 350 disposed at a bottom surface of the crawler track pad 300, as well as substantially between the through-holes 310. However, the mounting holes 340a and 340b are slightly offset from a central region of the alignment members 350.

In FIG. 7C, the mounting hole 340a, as well as the mounting hole 340b, includes an upper portion 342a and a lower portion 342b. Here, a diameter of the upper portion 342a is larger than a diameter of the lower portion 342b. In addition, as shown in FIG. 7B, the lower portion 342b extends to the bottom surface of the crawler track pad 300 at the alignment member 350.

In FIGS. 7C and 7D, the upper portion 342a includes a sidewall recess 344 that extends along an inner sidewall of the upper portion 342a. The sidewall recess 344 is positioned slightly biased towards the lower portion 342b, and includes upper and lower inclined surfaces 344a and 344b interconnected by a substantially vertical surface 344c. Here, for example, an angular separation of the upper and lower inclined surfaces 344a and 344b may be about 90°. In addition, the vertical surface 344c may be substantially parallel to the inner sidewall of the upper portion 342a.

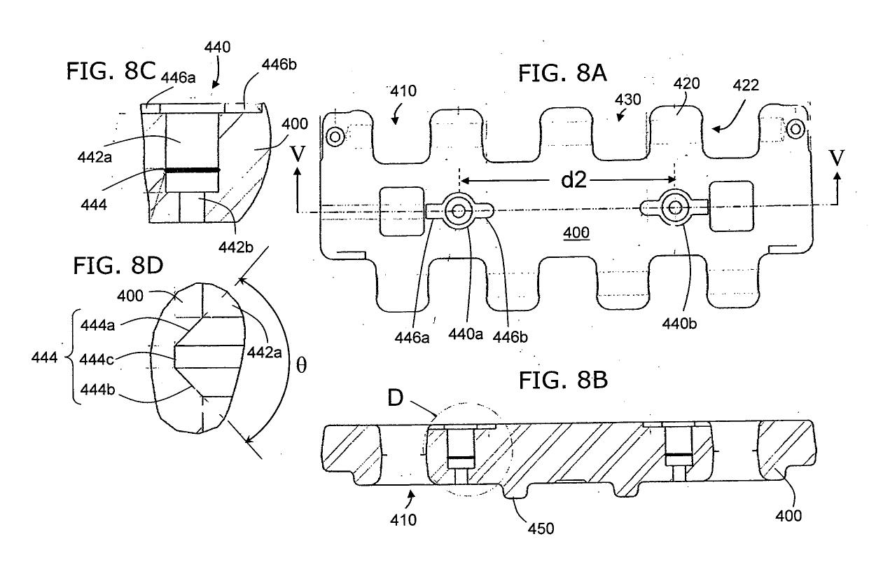

FIGS. 8A-8D are various views of another exemplary crawler track pad according to one embodiment. In FIG. 8A, a crawler track pad 400 may include a generally rectangular shape having a pair of through-holes 410 disposed at opposing ends. Here, for example, the through-holes 410 are generally rectangular and receive teeth of a drive sprocket and idler sprockets. In addition, the crawler track pad 400 includes a plurality of alternating finger portions 420 and recess portions 430, wherein through-holes 422 are provided within each of the finger portions 420 to receive connecting pins (not shown) to interconnect each of the crawler track pads 200, 300, and 400 (in FIGS. 1A and 1B). As shown, the finger portions 420 on a first side of the crawler track pad 400 oppose the recess portions 430 of a second side of crawler track pad 400.

In FIGS. 8A and 8B, a pair of substantially circular mounting holes 440a and 440b are provided substantially at a central location of the crawler track pad 400, and are separated from each other by a distance d2, which is greater than the distance d1 (in FIG. 7A). Here, each of the mounting holes 440a and 440b include a continuous recess having lateral portions 446a and 446b at a top surface of the crawler track pad 400. The lateral portion 446a extends from the mounting hole 440a towards the through-hole 410 by a distance substantially the same as the extension of the lateral portion 446b from the mounting hole 440a towards the mounting hole 440b. In addition, an end region of the lateral portion 446a is substantially flat, whereas an end region of the lateral portion 446b is rounded.

In FIG. 8B, each of the mounting holes 440a and 440b are positioned substantially between alignment members 450 disposed at a bottom surface of the crawler track pad 400 and the through-holes 410. However, the mounting holes 440a and 440b may be slightly biased in a direction towards the through-holes 410 than the alignment members 450.

In FIG. 8C, the mounting hole 440a, as well as the mounting hole 440b, includes an upper portion 442a and a lower portion 442b. Here, a diameter of the upper portion 442a is larger than a diameter of the lower portion 442b. In addition, as shown in FIG. 8B, the lower portion 442b extends to the bottom surface of the crawler track pad 400.

In FIGS. 8C and 8D, the upper portion 442a includes a sidewall recess 444 that extends along an inner sidewall of the upper portion 442a. The sidewall recess 444 is positioned slightly biased towards the lower portion 442b, and includes upper and lower inclined surfaces 444a and 444b interconnected by a substantially vertical surface 444c. Here, for example, an angular separation of the upper and lower inclined surfaces 444a and 444b may be about 90°. In addition, the vertical surface 444c may be substantially parallel to the inner sidewall of the upper portion 442a.

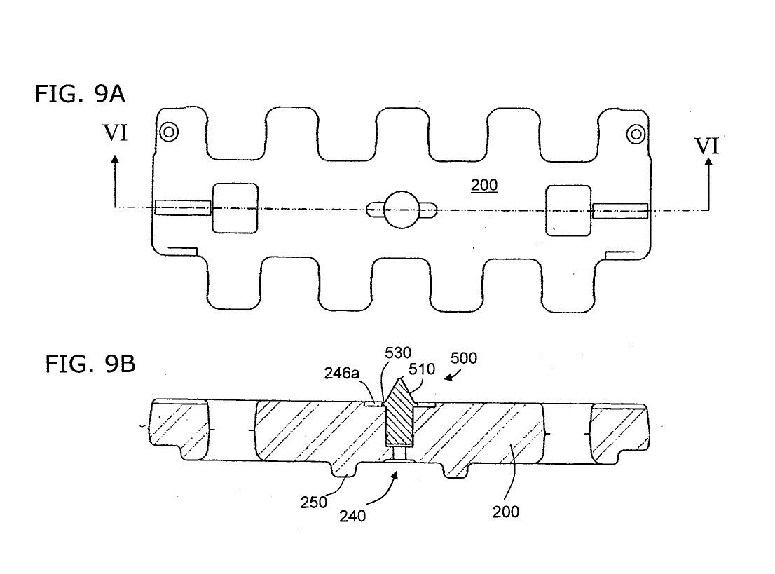

FIGS. 9A and 9B are top and cross-sectional views of the exemplary crawler track pad of FIGS. 6A-6D incorporating the exemplary caulk device of FIGS. 4A-4E according to one embodiment. In FIGS. 9A and 9B, a caulk device 500 may be inserted into the crawler track pad 200. For example, the retaining ring 524 (in FIGS. 5A and 5B) may be compressed and the cylindrical portion 520a of the caulk device 500 may be inserted into the upper portion 242a (in FIG. 6C) of the mounting hole 240. Accordingly, once the caulk device 500 is positioned within the mounting hole 240 at a specific depth, the retaining ring 524 (in FIG. 5C) may expand into the sidewall recess 244 (in FIGS. 6C and 6D), thereby locking the caulk device 500 into the mounting hole 240. Correspondingly, once at the specific depth, the flange portion 530 of the caulk device 500 is seated within the lateral portions 246a and 246b. As a result, the caulk device 500 is constrained within the mounting hole 240 with only the conical surface 510 protruding from the upper surface of the crawler track pad 200. In addition, as shown in FIG. 9B, the bottom surface 520c of the caulk device 500 is spaced apart from the lower portion 242b of the mounting hole 240.

After the caulk device 500 becomes worn, it may be easily removed from within the mounting hole 240 by using a press positioned within the lower portion 242b (in FIG. 6C). For example, after the useable lifetime of the caulk device 500 has been reached or the conical surface 510 is no longer within an acceptable range, the caulk device 500 may be removed, in situ, from the crawler track pad 200. Here, a user may simply position a pressing device (not shown) within the lower portion 242b to contact the bottom surface 520c (in FIG. 4A) of the caulk device 500. For purposes of alignment, the pressing device may use the lower recess 248.

Upon extending the pressing device upwardly into the mounting hole 240 from the bottom surface of the crawler track pad 200, the retaining ring 524 (in FIGS. 4C and 4E) may be forcibly compressed into the groove 522 (in FIGS. 4A, 4C, and 4D) by the upper inclined surface 244a of the mounting hole 240. Once compressed, the caulk device 500 may be further pressed completely out of the mounting hole 240, and a new replacement caulk device 500 may be reinserted, as detailed above.

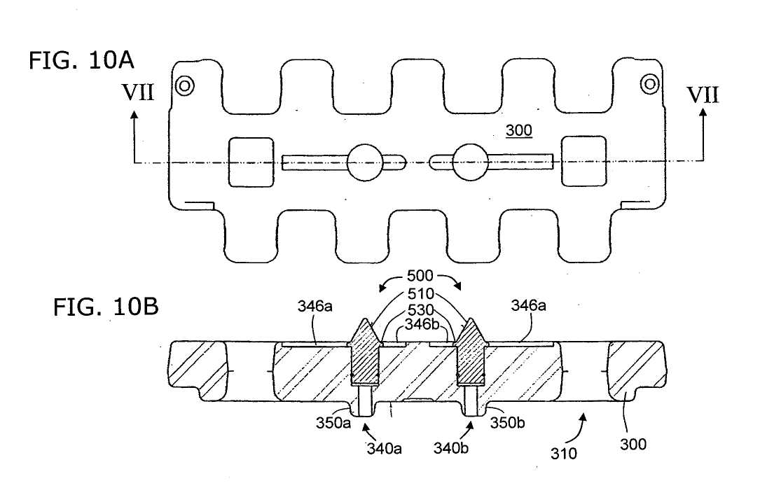

FIGS. 10A and 10B are top and cross-sectional views of the exemplary crawler track pad of FIGS. 7A-7D incorporating the exemplary caulk device of FIGS. 4A-4E according to one embodiment. In FIGS. 10A and 10B, a caulk device 500 may be inserted into the crawler track pad 300. For example, the retaining ring 524 (in FIGS. 5A and 5B) may be compressed and the cylindrical portion 520a of the caulk device 500 may be inserted into the upper portion 342a (in FIG. 7C) of the mounting holes 340a and 340b. Accordingly, once the caulk device 500 is positioned within the mounting holes 340a and 340b at a specific depth, the retaining ring 524 (in FIG. 5C) may expand into the sidewall recess 344 (in FIGS. 7C and 7D), thereby locking the caulk device 500 into the mounting holes 340a and 340b. Correspondingly, once at the specific depth, the flange portion 530 of the caulk device 500 is seated within the lateral portions 346a and 346b. As a result, the caulk device 500 is constrained within the mounting holes 340a and 340b with only the conical surface 510 protruding from the upper surface of the crawler track pad 300. In addition, as shown in FIG. 10B, the bottom surface 520c of the caulk device 500 is spaced apart from the lower portion 342b of the mounting holes 340a and 340b.

After the caulk device 500 becomes worn, it may be easily removed from within the mounting holes 340a and 340b by using a press positioned within the lower portion 342b (in FIG. 7C). For example, after the useable lifetime of the caulk device 500 has been reached or the conical surface 510 is no longer within an acceptable range, the caulk device 500 may be removed, in situ, from the crawler track pad 300. Here, a user may simply position a pressing device (not shown) within the lower portion 342b to contact the bottom surface 520c (in FIG. 4A) of the caulk device 500. For purposes of alignment, the pressing device may use the alignment members 350 and/or the through-holes 310.

Upon extending the pressing device upwardly into the mounting holes 340a and 340b from the bottom surface of the crawler track pad 300, the retaining ring 524 (in FIGS. 4C and 4E) may be forcibly compressed into the groove 522 (in FIGS. 4A, 4C, and 4D) by the upper inclined surface 344a of the mounting holes 340a and 340b. Once compressed, the caulk device 500 may be further pressed completely out of the mounting holes 340a and 340b, and a new replacement caulk device 500 may be reinserted, as detailed above.

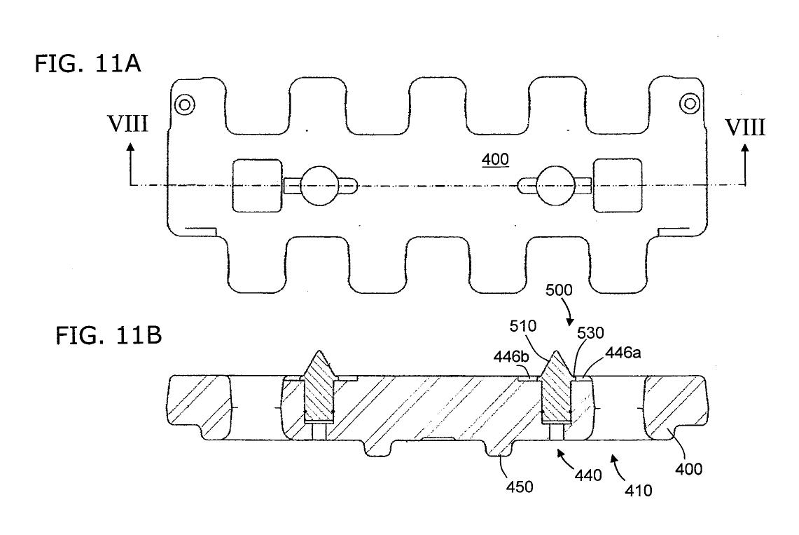

FIGS. 11A and 11B are top and cross-sectional views of the exemplary crawler track pad of FIGS. 7A-7D incorporating the exemplary caulk device of FIGS. 4A-4E according to one embodiment. In FIGS. 11A and 11B, a caulk device 500 may be inserted into the crawler track pad 400. For example, the retaining ring 524 (in FIGS. 5A and 5B) may be compressed and the cylindrical portion 520a of the caulk device 500 may be inserted into the upper portion 442a (in FIG. 8C) of the mounting holes 440. Accordingly, once the caulk device 500 is positioned within the mounting holes 440 at a specific depth, the retaining ring 524 (in FIG. 5C) may expand into the sidewall recess 444 (in FIGS. 8C and 8D), thereby locking the caulk device 500 into the mounting holes 440. Correspondingly, once at the specific depth, the flange portion 530 of the caulk device 500 is seated within the lateral portions 446a and 446b. As a result, the caulk device 500 is constrained within the mounting holes 440 with only the conical surface 510 protruding from the upper surface of the crawler track pad 400. In addition, as shown in FIG. 11B, the bottom surface 520c of the caulk device 500 is spaced apart from the lower portion 442b of the mounting holes 440.

After the caulk device 500 becomes worn, it may be easily removed from within the mounting holes 440 by using a press positioned within the lower portion 442b (in FIG. 8C). For example, after the useable lifetime of the caulk device 500 has been reached or the conical surface 510 is no longer within an acceptable range, the caulk device 500 may be removed, in situ, from the crawler track pad 400. Here, a user may simply position a pressing device (not shown) within the lower portion 442b to contact the bottom surface 520c (in FIG. 4A) of the caulk device 500. For purposes of alignment, the pressing device may use the alignment members 450 and/or the through-holes 410.

Upon extending the pressing device upwardly into the mounting holes 440 from the bottom surface of the crawler track pad 400, the retaining ring 524 (in FIGS. 4C and 4E) may be forcibly compressed into the groove 522 (in FIGS. 4A, 4C, and 4D) by the upper inclined surface 444a of the mounting holes 440. Once compressed, the caulk device 500 may be further pressed completely out of the mounting holes 440, and a new replacement caulk device 500 may be reinserted, as detailed above.

According to the present embodiments, caulk devices may be removable inserted into crawler track pads to increase traction of a crawler track used on various types of surface materials. In addition, the caulk devices may be easily replaced/removed with a minimum of down-time for the heavy machinery. As a result, a crawler track using removable caulk devices may be easily and cheaply removed/replaced.

According to the present embodiments, by selectively placing the caulk devices into the crawler track pads, traction may be increased. For example, by using a virtual “V”-shaped configuration of the caulk devices, traction of a crawler track may be improved. In addition, traction may be increased or reduced by only using select ones of the caulk devices in the individual crawler track pads. For example, for maximum traction, all of the crawler track pads may receive the caulk devices. Conversely, for minimum traction, none or only a few of the caulk device may be installed into the crawler track pads. Here, since the caulk devices can be installed into the crawler track pads using a simple pressing device, quick modification of the traction of the crawler track can be achieved.

According to the present embodiments, the caulk devices can be formed of different types of material(s) and can also have different types of geometries. For example, when using heavy machinery in extremely hard material(s), the caulk devices may be made of high strength material(s). Conversely, when using heavy machinery in relatively soft material(s), the caulk devices may be made of lower strength material(s). In addition, when the heavy machinery is moved from one worksite to another worksite, the caulk devices may be easily and quickly removed so as to not damage surrounding worksite areas, i.e. roadways and construction pathways.

While certain embodiments have been described above, it will be understood that the embodiments described are by way of example only. Accordingly, the invention(s) should not be limited based on the described embodiments. Rather, the scope of the invention(s) described herein should only be limited in light of the claims that follow when taken in conjunction with the above description and accompanying drawings.

What is claimed is:

1. A crawler track device, comprising:
a plurality of crawler track pads, each coupled to form a continuous crawler track,
wherein each of the plurality of crawler track pads includes at least one mounting hole configured to removably receive at least one of a plurality of caulk devices that each protrude from an upper surface of the crawler track pad.

2. The device of claim 1, wherein the at least one mounting hole extends through the crawler track pad.

3. The device of claim 2, wherein the at least one mounting hole includes an upper portion having a diameter substantially the same as a diameter of the at least one of the plurality of caulk devices and a lower portion having a diameter smaller than the diameter of the at least one of the plurality of caulk devices.

4. The device of claim 1, wherein the plurality of crawler track pads includes a first crawler track pad having only a single one of the mounting holes substantially located within a central portion of the first crawler track pad and one of the caulk devices disposed within the single mounting hole.

5. The device of claim 4, wherein the first crawler track includes a first pair of alignment members disposed on a lower surface of the first crawler track.

6. The device of claim 5, wherein the single one of the mounting holes is disposed between the first pair of alignment members.

7. The device of claim 4, wherein the plurality of crawler track pads includes a second crawler track pad having only a first pair of the mounting holes substantially located within a central portion of the second crawler track pad and spaced apart by a first distance, and one of the caulk devices disposed within each of the first pair mounting holes.

8. The device of claim 7, wherein the second crawler track includes a second pair of alignment members disposed on a lower surface of the second crawler track and separated by the first distance.

9. The device of claim 8, wherein the first pair of the mounting holes extend through the second pair of alignment members.

10. The device of claim 7, wherein the plurality of crawler track pads includes a third crawler track pad having only a second pair of the mounting holes substantially located within a central portion of the third crawler track pad and spaced apart by a second distance different from the first distance, and one of the caulk devices disposed within each of the second pair mounting holes.

11. The device of claim 10, wherein the third crawler track includes a third pair of alignment members disposed on a lower surface of the third crawler track and separated by a third distance.

12. The device of claim 11, wherein the third distance is greater than the second distance.

13. The device of claim 10, wherein the first, second, and third crawler track pads are periodically provided along the crawler track.

14. The device of claim 1, wherein the at least one of the plurality of caulk devices each include a body portion disposed within the mounting hole, a flange portion substantially coplanar with an upper surface of the plurality of crawler track pads, and a protruding portion that protrudes from the upper surface of the plurality of crawler track pads.

15. The device of claim 14, wherein the protruding portion includes a geometry such that an outer circumference increases from a tip of the protruding portion to the flange portion.

16. The device of claim 14, wherein the caulk devices each include a retaining ring disposed within a recess circumferentially disposed about the body portion.

17. The device of claim 16, wherein the at least one mounting hole includes a sidewall recess for removably receiving the retaining ring when the caulk device is fully inserted into the at least one mounting hole.

18. The device of claim 17, wherein the retaining ring is compressed into the recess of the body portion from the sidewall recess when the caulk device is removed from the at least one mounting hole.

19. The device of claim 18, wherein removal of the caulk device from the at least one mounting hole includes application of force from the bottom surface to the top surface of the crawler track pad.

20. A crawler track pad, comprising:
a generally rectangular shaped pad body having a pair of through-holes disposed at opposing ends for receiving teeth of a drive sprocket and idler sprockets from a bottom surface to a top surface of the pad body;
a pair of alignment members disposed on the bottom surface of the pad body and spaced apart by a first distance;
a plurality of alternating finger portions and recess portions, the plurality of finger portions on a first side of the pad body oppose the recess portions on a second side of the pad body;
at least one substantially circular mounting hole provided at a central location of the pad body and configured to removably receive one of a plurality of caulk devices; and
a continuous recess in the top surface of the pad body having lateral portions at both sides of the at least one mounting hole,
wherein the pad body includes at least one of:
a single one of the at least one mounting hole substantially located within the central portion of the pad body, and one of the plurality of caulk devices disposed within the single mounting hole; and
a pair of the at least one mounting hole substantially located within the central portion of the pad body and spaced apart by one of the first distance and a second distance that is greater than the first distance, and one of the plurality of caulk devices disposed within each of the pair of mounting holes.

21. The device of claim 20, wherein the plurality of caulk devices each include a body portion disposed within the at least one mounting hole, a flange portion substantially coplanar with the top surface of the pad body, and a protruding portion that protrudes from the upper surface of the pad body.

22. The device of claim 21, wherein an outer circumference of the protruding portion increases from a tip of the protruding portion to the flange portion.

23. The device of claim 22, wherein the protruding portion includes a conical surface.

24. The device of claim 21, wherein the at least one mounting hole includes an upper portion having a diameter substantially the same as a diameter of the plurality of caulk devices and a lower portion having a diameter smaller than the diameter of the plurality of caulk devices.
